(19) United States
(12) Patent Application Publication
(10) Pub. No.: US 2017/0005686 A1
(43) Pub. Date: Jan. 5, 2017

(54) HOLSTER SYSTEM

(71) Applicant: iHIDE LLC, Bloomfield Hills, MI (US)

(72) Inventors: Jeffrey Russell Borisen, Farmington Hills, MI (US); Cyrus Ian Karimipour, Bloomfield Hills, MI (US)

(21) Appl. No.: 15/197,922

(22) Filed: Jun. 30, 2016

Related U.S. Application Data
(60) Provisional application No. 62/187,621, filed on Jul. 1, 2015.

(51) Int. Cl. H04B 1/3888; A45F 5/02; H04B 1/3827; A45C 11/00

(52) U.S. Cl. CPC H04B 1/3888; A45C 11/00; A45F 5/021; H04B 1/385; A45C 2011/002

(57) ABSTRACT

A mobile communication device holster may include a frame that may include an inner portion that may be configured to be disposed adjacent to a body of a wearer, an outer portion that may be configured to be disposed adjacent to a support structure, and a plurality of spacers disposed between the inner portion and the outer portion. The inner portion and the outer portion may define a cavity that may be configured to receive at least a portion of a mobile communication device.

### CROSS-REFERENCE TO RELATED APPLICATION

This application claims the benefit of U.S. Provisional Patent Application Ser. No. 62/187,621, filed Jul. 1, 2015, the disclosure of which is hereby incorporated herein by reference in its entirety.

### TECHNICAL FIELD

The present disclosure relates to the field of mobile communications. More specifically, the present disclosure includes a method and system for carrying a devices, such as, for example, a mobile communication device.

### BACKGROUND

There are many known devices and methods that aid a person in the ability to carry a mobile communication device on him/herself. For example, previous designs include an exterior waistband holster, such as for the Apple iPhone®. Other methods of carrying, a mobile communication device may including carrying the device in a pocket of a pair pants or shirt, in a purse, in a jacket/coat, or in a bag.

In recent years, mobile communication devices have become larger in size due to popularity of bigger display screens. This trend has made it difficult for individuals who wish to carry their mobile communication devices on their person. Carrying such devices can he more uncomfortable and cumbersome than ever before. Consequently, outside waistband holsters have also become larger in size. Large mobile devices carried outside by a belt holster system can look awkward and overly bold in appearance. As a result, these type of holsters are now more likely to come into physical contact with other objects, such as wall corners, seatbelts, and other external objects. Such contact can cause mobile communication devices and/or the other objects to become damaged by force of impact with objects or from freefalling due to failure of outside waistband holsters. The present disclosure includes a new method and system of carrying a device, such as a mobile communication devices on one's person.

### SUMMARY

An embodiment of the present disclosure includes a mobile communication device holster that may comprise a frame that may include an inner portion that may be configured to be disposed adjacent to a body of a wearer/user, an outer portion that may be configured to be disposed adjacent to a support structure, and a plurality of resilient spacers disposed between the inner portion and the outer portion. The inner portion and the outer portion may define a cavity that may be configured to receive at least a portion of a mobile communication device.

Various aspects of the present disclosure will become apparent to those skilled in the art from the following detailed description of the various embodiments, when read in light of the accompanying drawings.

### BRIEF DESCRIPTION OF THE DRAWINGS

FIGS. 1 is an isometric view of a holster according to an embodiment of the present disclosure.

FIG. 1A is an isometric view of a holster according to an embodiment of the present disclosure.

FIG. 2 is a front view of a holster according to an embodiment of the present disclosure.

FIG. 3 is a side view of a holster according to an embodiment of the present disclosure.

FIG. 3A is a side view of a holster according to an embodiment of the present disclosure.

FIG. 4 is a top view of a holster according to an embodiment of the present disclosure.

FIG. 5 is a back view of a holster according to an embodiment of the present disclosure.

FIG. 6 is a perspective view of a holster according to an embodiment of the present disclosure.

FIG. 7 is a perspective view of a holster according to an embodiment of the present disclosure.

### DETAILED DESCRIPTION

Various embodiments of the present disclosure are described more fully hereinafter with reference to the accompanying drawings, in which some, but not all embodiments of the present disclosure are shown in the figures. Indeed, the present disclosure may be embodied in many different forms and should not be construed as limited to the embodiments set forth herein; rather, these embodiments are provided so that this disclosure will satisfy applicable legal requirements.

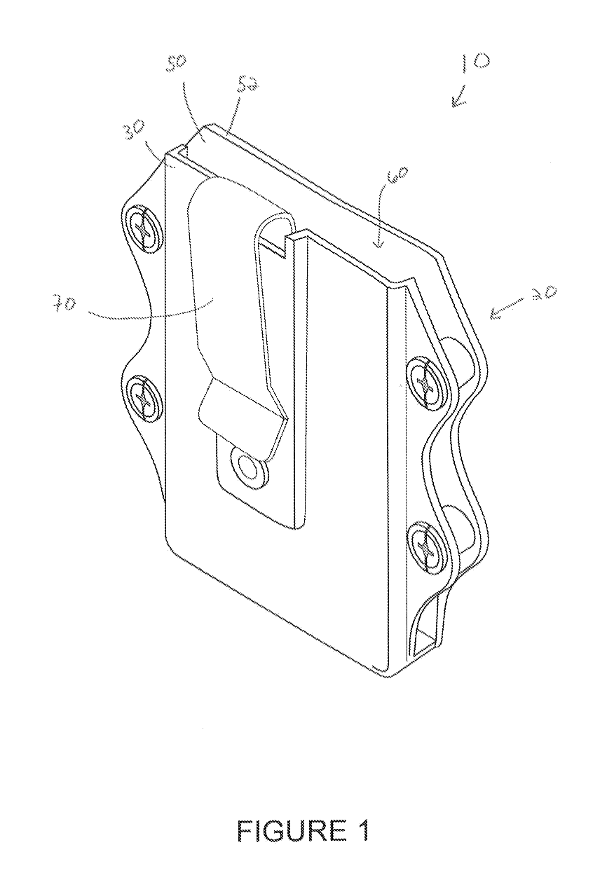

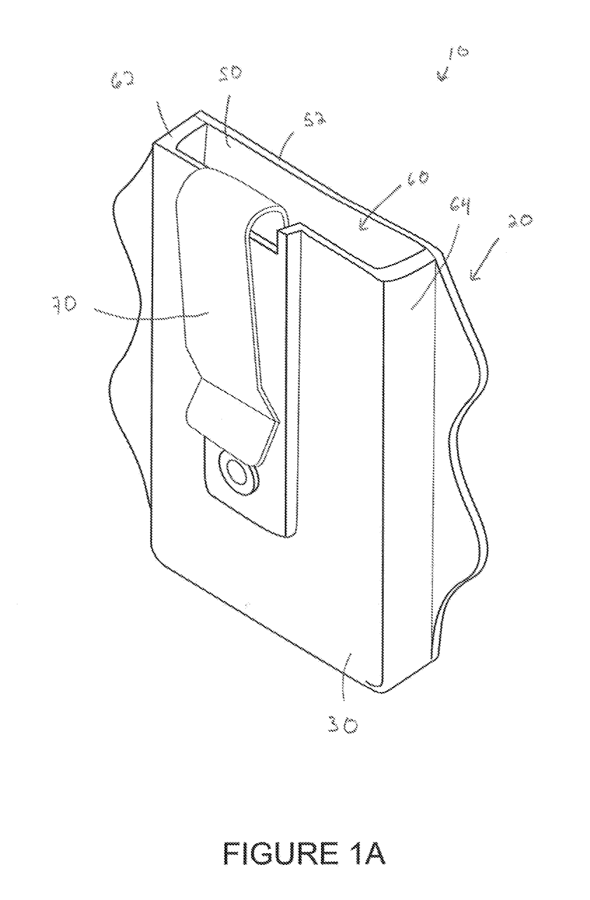

Referring to the drawings, FIGS. 1 and 1A generally illustrate embodiments of a holster 10, in embodiments, a holster 10 may include a frame 20 that may include one or more of a variety of shapes, sizes, configurations, and/or materials. For example, and without limitation, frame 20 may include a hard material such as plastic, rubber, wood, leather, and/or or metal. In embodiments, frame 20 may include an outer portion 30 and/or an inner portion 50. Outer portion 30 and inner portion 50 may be configured to correspond to a shape/contour of a device 12 to be carried, such as a mobile communication device. Device 12 may be referred to herein as mobile communication device 12. For example, outer portion 30 and inner portion 50 may define a cavity 60 that may allow for the device 12 to be easily inserted into holster 10 and/or easily removed from holster 10. In embodiments, frame 20 may be configured to provide a retaining force that may be adequate to prevent device 12 from unintentionally being removed from holster 10 and/or reduce the likelihood that device 12 will be unintentionally removed from holster 10. In embodiments, frame 20 may be sufficiently rigid to allow cavity 60 to generally retain its shape, while still allowing for easy insertion and removal of a mobile communication device 12.

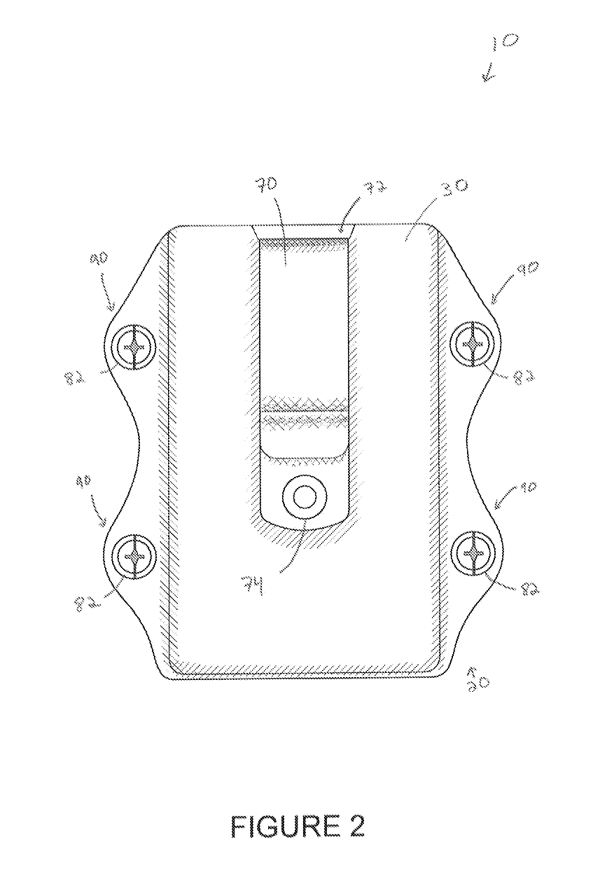

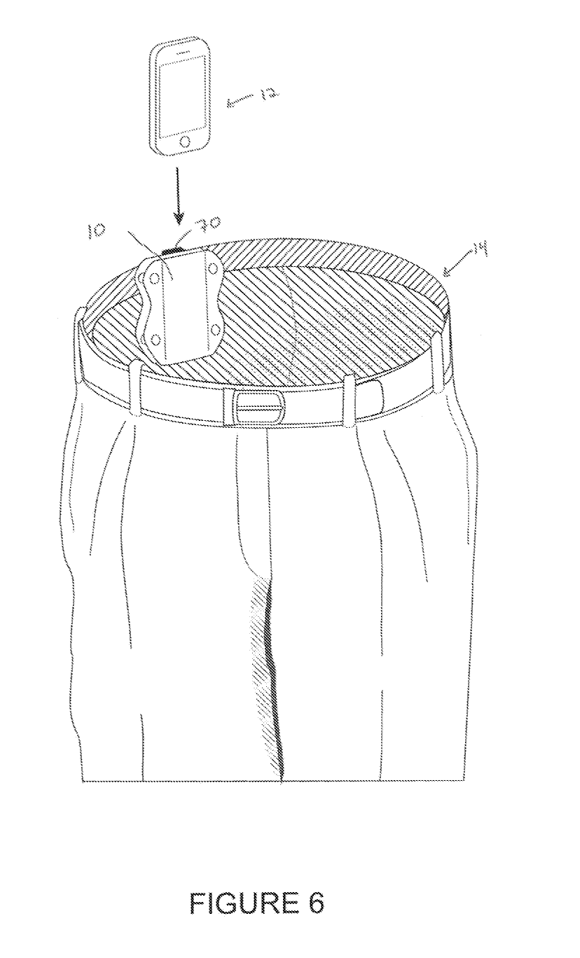

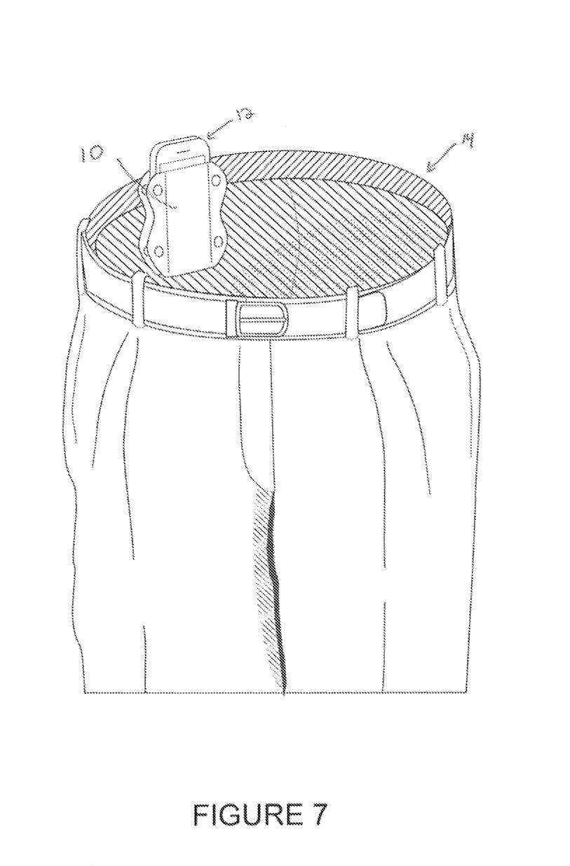

in embodiments, such as generally illustrated in FIG. 2, outer portion 30 of holster 10 may be configured for use in conjunction with a support structure 14, such as, for example, a pair of pants, a belt, and/or tall footwear (see, e.g., FIGS. 6 and 7). In embodiments, holster 10 may be configured to be disposed against an inseam of a pair of pants or of tall footwear. In embodiments, holster 10 may include a clip 70 that may be configured for securing holster system to a support structure 14. In embodiments, clip 70 may be attached to outer portion 30 of holster 10. In embodiments, clip 70 may be removable and holster 10 may be used with or without clip 70. In embodiments, such as generally illustrated in FIGS. 1, 1A, 2, 3, and 3A, outer portion 30 may include a clip receiving slot 72 that may be configured to receive clip 70. Clip receiving slot 72 may include a fastener 74 that may be configured to at least temporarily secure clip 70 to outer portion 30. For example, and without limitation, clip 70 and clip receiving slot 72 may include corresponding projections and detents.

In embodiments, outer portion 30 and/or inner portion 50 may include a generally rectangular shape. In embodiments, outer portion 30 and/or inner portion 50 may include one or more flange portions 90 that may extend laterally outward (e.g., generally circumferentially). Spacers 80 and/or fasteners 82 may be connected to outer portion 30 and/or inner portion 50 at flange portions 90. For example, and without limitation, each of outer portion 30 may include four outer flange portions 90 and/or inner portion 50 may include four inner flange portions 90 (e.g., holster 10 may include a total of eight flange portions 90) that may be generally aligned with each other in opposing sets of two flange portions.

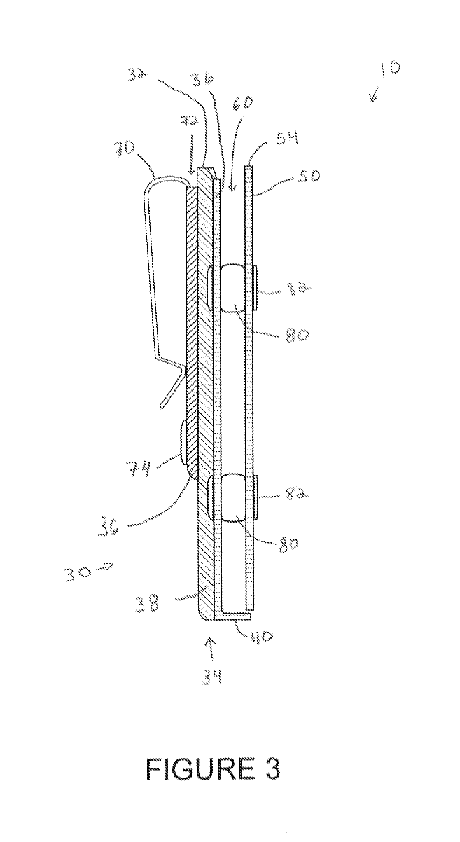

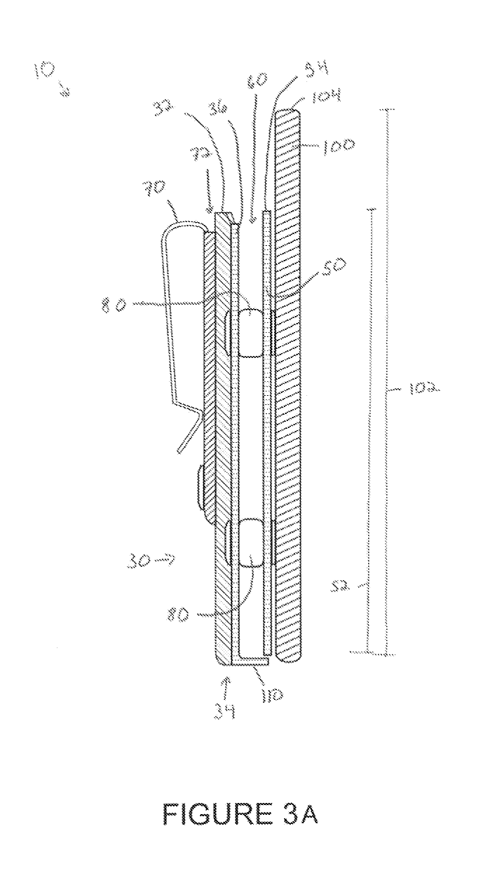

In embodiments, such as generally illustrated in FIG. 3, one or more spacers 80 may be disposed between outer portion 30 and inner portion 50 (e.g., between respective flange portions 90). Spacers 80 may include one or more of a variety of shapes, sizes, configurations, and/or materials. For example, and without limitation, spacers 80 may be at least somewhat resilient, may include rubber and/or may include plastic. Spacers 80 may prevent holster cavity 60 from closing when a device 12 is not disposed in cavity 60. Additionally or alternatively, side walls 62, 64 may connect outer portion 30 and inner portion 50 (see, e.g., FIG. 1A). In embodiments, side walls 62, 64 may include a hard, solid material. Side walls 62, 64 may extend from one or both of outer portion 30 and inner portion 50. In embodiments, outer portion 30 and inner portion 50 may be connected to each other via side walls and/or a connector (e.g., fasteners, glues, epoxies, etc.). In embodiments, outer portion 30 and inner portion 50 may be discrete/separate components. Side walls may, for example, be at least somewhat resilient and/or may provide a retaining force that may help retain a mobile communication device 12 at least partially within holster 10.

In embodiments, one or more fasteners 82 (e.g., screws, bolts, rivets, etc.) may extend through/into one or more of outer portion 30, inner portion 50, flange portions 90, and/or spacers 80 to secure outer portion. 30 and inner portion 50 with each other. in embodiments, fasteners 82 may. In embodiments, a respective spacer 80 may be disposed between each set of two corresponding flange portions 90. In embodiments, flange portions 90 may he generally curved, and/or flange portions 90 on the same side of holster 10 (e.g., side 10A and/or 10B) may be disposed in a generally wave-like configuration.

In embodiments, such as generally illustrated in FIG. 3A, holster 10 may include padding 100 that may be connected to inner portion 50. For example, and without limitation, padding 100 may be connected to inner portion 50 via hook and loop fasteners (e.g., Velcro®). Padding 100 may include one or more materials that may be connected (e.g., sewn) together. Padding 100 may be configured to prevent materials that may be in proximity to cavity 60 from being pinched inside cavity 60 (e.g., skin of a wearer, clothing, etc.). In embodiments, padding 100 may include a width that may generally correspond to the width of inner portion 50 and/or may include a height/length 102 that is at least as large or larger than the height/length 52 of inner portion 50. In embodiments, padding 100 may be disposed such that a top 104 of padding 100 extends vertically higher than the top 54 of inner portion 50 and/or the top 32 of outer portion 30.

In embodiments, such as generally illustrated in FIGS. 3 and 3A, holster 10 may include a retaining element 110 that may be configured to prevent vertical movement of a mobile communication device 12 in at least one direction. In embodiments, retaining element 110 may comprise a protrusion. In embodiments, outer portion 30 may include retaining element 110 and retaining element 110 may be configured to prevent device 12 from moving vertically downward beyond retaining element 110 (e.g., prevent device from moving/passing completely through cavity 60 and/or holster 10). For example, and without limitation, retaining element 110 may extend laterally from a bottom 34 of outer portion 30 and toward inner portion 50. In embodiments, retaining element 110 may extend toward inner portion 50, but may not extend all of the way to inner portion 50. In other embodiments, retaining element 110 may extend below inner portion 50 and/or intersect a plane of inner portion 50. In other embodiments, retaining element 110 may extend inner portion 50 toward outer portion 30 and/or both of outer portion 30 and inner portion 50 may include retaining elements 110 that extend toward each other.

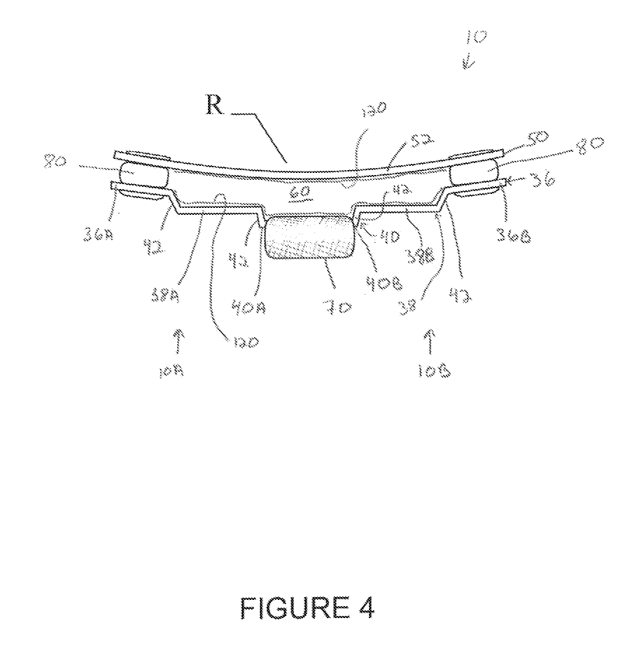

In embodiments, such as generally illustrated in FIG. 4, inner portion 50 may be curved and/or include a radius R. In embodiments, the curvature may be uniform. For example, and without limitation, the curvature of inner portion 50 may be between about 15 degrees and 30 degrees. Additionally or alternatively, the curvature may be specifically designed for a particular wearer. For example, and without limitation, inner portion 50 may be formed and/or molded according to the portion of a wearer that inner portion 50 is expected to be disposed against during use (e.g., a hip area of a wearer). The curvature and/or custom forming may allow for holster 10 to be worn more comfortably and/or may reduce visual “printing” on the outside of clothing (e.g., may make holster 10 less noticeable to observers).

In embodiments, the inside of the cavity 60 may be lined with a protective material 120, such as, for example, a soft fiber material, that may prevent and/or reduce scratching of mobile communication device 12 when device is inserted into, removed from, and/or stored in holster 10. For example, and without limitation, one or both of outer portion 30 and inner portion 50 may be include a soft fiber material 120 (e.g., a first layer of protective material 120 may be connected to outer portion 30 and/or a second layer of protective materials 120 may be connected to inner portion 50). In embodiments, the protective material 120 may be configured to clean a screen of a mobile communication device 12 (e.g., during insertion and/or removal).

In embodiments, outer portion 30 may be generally planar. In other embodiments, such as generally illustrated in FIG. 4, outer portion 30 may include a tiered configuration that may include one or more tiers, such as a first tier 36, a second tier 38, and/or a third tier 40. First tier 36, second tier 38, and/or third tier 40 may be disposed in a stepped arrangement, which may include first tier 36 being disposed closer to inner portion 50 than second tier 38 and/or third tier 40, and second tier 38 may be closer to inner portion 50 than third tier 40. In embodiments, first tier 36 may be configured to be disposed near or adjacent to spacers 80. In embodiments, each tier 36, 38, 40 may include a first portion 36A, 38A, 40A, disposed at a first side 10A of holster 10 and/or a second portion 36B, 38B, 40B disposed at a second side 10B of holster. In embodiments, adjacent tiers (e.g., first tier 36 and second tier 38, and/or second tier 38 and third tier 40) may be connect to each other via angled sections 42. En embodiments, clip 70 may be connected to third tier 40. In embodiments, first tier 36, second tier 38, third tier 40, and/or angled sections 42 may be disposed in as generally curved configuration that may correspond to the curvature of inner portion 50, if any.

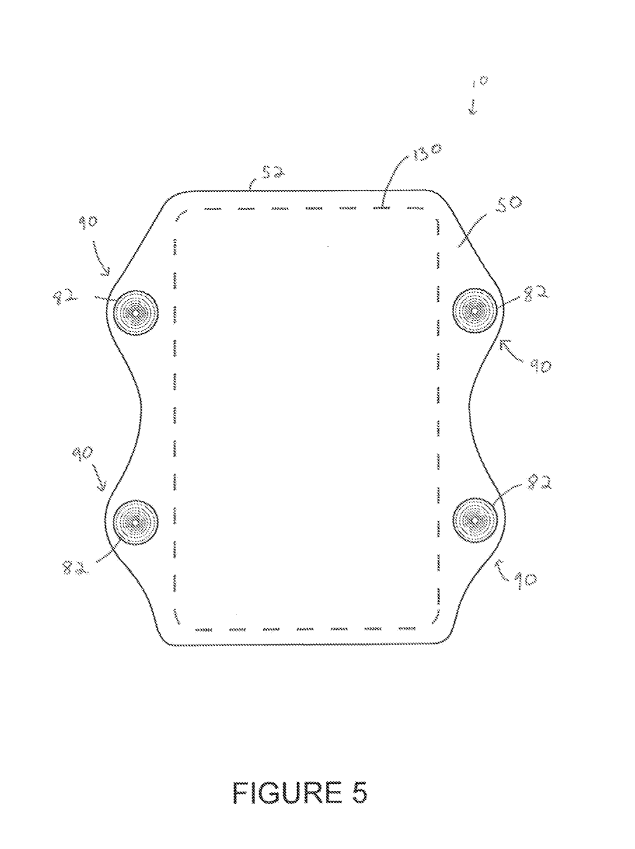

In embodiments, such as generally illustrated in FIG. 5, inner portion 50 may include an electromagnetic radiation (EMR) shield 130. In embodiments, an EMR shield 130 may be configured to reduce or eliminate electromagnetic radiation, which may be generated by and/or for a mobile communication device 12, from passing through some or all of inner portion 50, which may reduce or eliminate the exposure of a wearer of holster to such radiation. In embodiments, an EMR shield 130 may include one or more of a variety of shapes, sizes, and/or configurations, such as including conductive and/or magnetic material.

In embodiments, such as generally illustrated in FIGS. 6 and 7, one method of using holster 10 may include a wearer/user wearing holster 10 inside a support structure 14, such as a waistline of a pair of pants. In embodiments, holster 10 may be worn with or without clip 70. If holster 10 is worn without clip 70, holster 10 may be held in place via friction between the body of a wearer and support structure 14 (e.g., the inseam of a pant waistline area or tall footwear).

In embodiments, holster 10 may be configured to partially and/or fully conceal a mobile communication device 12 on one's person from inside a support structure 14, which may include holster 10 itself being configured to be worn concealed. For example, and without limitation, holster 10 may be configured such that at least 90% of holster 10 is concealed (e.g., disposed laterally within and vertically below a top of support structure 14). In embodiments, holster 10 may be configured to receive at least half of a mobile communication device 12. For example, and without limitation holster 10 may be configured to receive at least 85% of a mobile communication device 12 (e.g., such that 15% or less of the mobile communication device extends vertically above/beyond the top of holster upon complete insertion).

In embodiments, concealing holster 10 may reduce the likelihood that mobile communication device 12 will come into physical contact with other objects, such as walls, corners, seatbelts, and/or other external objects. Such contact may be undesirable, as it may cause the mobile communication device 12 and/or the other objects to become damaged by force of impact or from device 12 falling (e.g., to the ground). Additionally or alternatively, concealing holster 10 and/or mobile communication device 12 may make it more difficult for third parties (e.g., a potential thief) to notice that a wearer is in possession of the mobile communication device 12.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. in other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated, or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure as defined in the appended claims.

What is claimed is::

1. A mobile communication device holster, comprising:
a frame comprising:
an inner portion configured to be disposed adjacent to a body of a user;
an outer portion configured to be disposed adjacent to a support structure; and
a plurality of spacers disposed between the inner portion and the outer portion;
wherein the inner portion and the outer portion define a cavity configured to receive at least a portion of a mobile communication device.

2. The mobile communication device holster of claim 1, comprising a clip connected to the outer portion.

3. The mobile communication device holster of claim 2, wherein the clip is configured to connect with at least one of pants and a belt.

4. The mobile communication device holster of claim 1, wherein the outer portion includes a plurality of outer flanges.

5. The mobile communication device holster of claim 4, wherein the inner portion includes a plurality of inner flanges.

6. The mobile communication device holster of claim 5, wherein each of the plurality of spacers is disposed between an outer flange of the plurality of outer flanges and an inner flange of the plurality of inner flanges.

7. The mobile communication device holster of claim 1, comprising a padding layer connected to the inner portion.

8. The mobile communication device holster of claim 7, wherein a length of the padding layer is longer than a length of the inner portion.

9. The mobile communication device holster of claim 1, comprising a first layer of protective material connected to the outer portion and a second layer of protective material connected to the inner portion.

10. The mobile communication device holster of claim 1, wherein a portion of the inner portion is curved.

11. The mobile communication device holster of claim 10, wherein the inner portion is curved outward toward the outer portion.

12. The mobile communication device holster of claim 1, wherein the outer portion includes a plurality of tiers.

13. The mobile communication device holster of claim 12, Wherein the plurality of tiers includes a first tier, a second tier, and a third tier.

14. The mobile communication device holster of claim 12, comprising angled sections connecting the plurality of tiers.

15. The mobile communication device holster of claim 1, wherein the inner portion includes an electromagnetic shield.

16. The mobile communication device holster of claim 1, wherein the mobile communication device holster is configured to be disposed between the body of said user and said support structure.

17. The mobile communication device holster of claim 1, wherein the inner portion and the outer portion are separate components.

18. A method of supporting a mobile device, the method comprising:
providing a support structure;
providing a mobile device holster, the mobile device holster including:
an inner frame portion configured to be disposed adjacent to a body of a wearer;
an outer frame portion configured to be disposed adjacent to the support structure; and
a plurality of spacers disposed between the inner frame portion and the outer frame portion;
disposing at least a portion of the mobile device in a cavity defined between the inner frame portion and the outer frame portion; and
disposing the mobile device holster at least partially within the support structure.

19. The method of claim 18, wherein disposing the mobile device holster at least partially within the support structure includes disposing at least about 90% of the mobile device holster below a top of the support structure.

20. The method of claim 18, wherein the mobile device holster includes a clip connected to the outer frame portion, and the method of supporting the mobile device includes connecting the clip to the support structure.
